(19) United States
(12) Patent Application Publication
(10) Pub. No.: US 2015/0185723 A1
(43) Pub. Date: Jul. 2, 2015

(54) FACILITY CONTROLLING SYSTEM AND HISTORY RECORDING METHOD

(71) Applicant: Azbil Corporation, Tokyo (JP)

(72) Inventor: Takashi NOGUCHI, Tokyo (JP)

(73) Assignee: Azbil Corporation, Tokyo (JP)

(21) Appl. No.: 14/571,694

(22) Filed: Dec. 16, 2014

(30) Foreign Application Priority Data
Dec. 27, 2013 (JP) 2013-272137

(51) Int. Cl. G05B 15/02

(52) U.S. Cl. CPC G05B 15/02

(57) ABSTRACT

A facility controlling system includes a plurality of controllers that controls remotely various types of equipment instruments that are installed in building facility, and a device monitoring node that monitors these controllers through a communication circuit. A monitoring controlling portion of the device monitoring node pauses monitoring, in a device monitoring portion, for an applicable controller in response to a report from the controller that a specific operating mode has been started, and restarts, in the device monitoring portion, monitoring for the applicable controller in response to a report from the controller that the specific operating mode has been terminated.

### CROSS REFERENCE TO RELATED APPLICATION

This application claims priority under 35 U.S.C. §119 to Japanese Patent Application No. 2013-272137, filed on Dec. 27, 2013, the entire content of which being hereby incorporated herein by reference.

### FIELD OF TECHNOLOGY

The present invention relates to a technology for facility control and, in particular, relates to a history recording technology for recording a history of the operating statuses of controllers for controlling equipment instruments.

### BACKGROUND

In a facility controlling system for monitoring and controlling building facility in buildings, industrial plants, and the like, in order to handle changes in equipment instrument reporting, additions or changes in control points, and the like, it is necessary to execute operations for downloading from an engineering tool in order to update settings data, applications, firmware, and the like used by controllers that control equipment instruments, even after the system is in operation.

Conventionally, as technologies relating to such download operations, there have been proposals for technologies that enable the operating mode of a control processing portion that carries out the control of an equipment instrument to be changed independently of changes in the operating mode of the communication processing portion that carries out communication with various types of higher-level devices. See, for example, Japanese Unexamined Patent Application Publication 2001-333128. This enables an improvement in system reliability through making it possible to carry out download operations by changing the communication processing portion to an offline state with the applications, such as for instrument control in the control processing portion, still in the operating state, without having to stop operations, even when it is necessary to carry out a download operation that produces a change in a communication parameter, such as a network variable or a network structures.

Such a facility controlling system is provided with a device monitoring node as one of the various devices that are hierarchically above the controller, in order to monitor, and record as history, the operating status of each controller at all times. This history can be analyzed to enable proper handling of faults that occur in a controller, and to enable proper fault analysis.

On the other hand, in the download operation according to the conventional technology, described above, the operating mode of the controller is changed to an offline state that pauses control of the equipment instrument, where the operating mode of the controller is returned to the online state, wherein the equipment instrument is controlled, after the download operation has been completed. For example, in BACnet, which is a communication protocol for intelligent buildings, the controller is removed/installed. Because of this, the operations for switching operating modes for download operations, and the statuses wherein a controller becomes non-responsive to status queries from the device monitoring node due to moving into an offline state, are recorded as an operating history or warning history for the controller.

However, the download operation is one of the maintenance operations performed by a maintenance manager, and, for such download operations, the operating history or warning history for the controller are details that do not actually have to be recorded. Because of this, in the conventional technology, useless history is recorded, increasing the volume of history data and interfering with storage and analysis of the history.

Moreover, typically a maintenance manager is required to explain to the user the history of warnings that occur in controllers while a facility controlling system is operating. As a result, there is a problem in that this requires detailed explanations to be made to the user regarding operating statuses that actually do not require responses to the warnings, which results in wasted operating time. In particular, in large-scale building facility, such as in a building or in an industrial plant, wherein a large number of controllers are installed, if download operations are carried out all at once for these controllers, the warning histories for these various controllers are centralized, making these problem areas extremely serious.

The present invention is to solve problem areas such as this, and an aspect thereof is to provide a history recording technology wherein it is possible to avoid needlessly recording of operating histories and warning histories in relation to downloading operations.

### SUMMARY

In order to achieve such an aspect, a facility controlling system according to the present invention includes a plurality of controllers that remotely controls various types of equipment instruments that are installed in building facility, and a device monitoring node that monitors these controllers through a communication circuit.

The controller includes an operating status reporting portion that reports to the device monitoring node, at a download start time for starting downloading of a file from an engineering tool that is connected through a communication circuit, that a specific operating mode has been started, and reports to the device monitoring node, at a download termination time when downloading of the file has been terminated, that the specific operating mode has been terminated.

The device monitoring node includes a device monitoring portion that intermittently monitors the individual controllers through the communication circuit and records the operating statuses obtained into a history recording portion for each individual controller, and a monitoring controlling portion that pauses monitoring in the device monitoring portion, for the applicable controller, in response to a report from the controller that a specific operating mode has been started, and restarts monitoring in the device monitoring portion, for the applicable controller, in response to a report from the controller that the specific operating mode has been terminated.

Moreover, another facility controlling system according to the present invention includes a plurality of controllers that remotely controls various types of equipment instruments that are installed in building facility, and a device monitoring node that monitors these controllers through a communication circuit.

The controller includes an operating status reporting portion that reports, to the device monitoring node, at a download start time for a file from an engineering tool that is connected through a communication circuit, that a specific operating mode has been started, and reports, to the device monitoring node, when downloading of the file has been terminated, that the specific operating mode has been terminated.

The device monitoring node includes a device monitoring portion that intermittently monitors the individual controllers through the communication circuit and recording the operating statuses obtained into a history recording portion for each individual controller, and a monitoring controlling portion that pauses recording, into the recording history portion in the device monitoring portion, of the operating status of the applicable controller, in response to a report from the controller that a specific operating mode has been started, and restarts recording, into the recording history portion in the device monitoring portion, of the operating status of the applicable controller, in response to a report from the controller that the specific operating mode has been terminated.

Moreover, a history recording method according to the present invention is a history recording method that is used in facility controlling system includes a plurality of controllers for remotely controlling various types of equipment instruments that are installed in building facility, and a device monitoring node for monitoring these controllers through a communication circuit.

The history recording method includes: an operating mode reporting step wherein, at a download start time for a file from an engineering tool that is connected through a communication circuit, an operating status reporting portion of the controller reports to the device monitoring node that a specific operating mode has been started, and, when downloading of the file has been terminated, reports to the device monitoring node that the specific operating mode has been terminated; a device monitoring step wherein a device monitoring portion of the device monitoring node monitors each controller intermittently, through the communication line, records, to a history recording portion, an operating status that is obtained for each aforementioned controller; and a monitoring controlling step wherein a monitoring controlling portion of the device monitoring node pauses, in the device monitoring portion, monitoring of the applicable controller in response to a report from the controller that a specific operating mode has been started, and restarts, in the device monitoring portion, monitoring of the applicable controller in response to a report from the controller that the specific operating mode has been terminated.

Moreover, another history recording method according to the present invention is a history recording method that is used in facility controlling system includes a plurality of controllers for remotely controlling various types of equipment instruments that are installed in building facility, and a device monitoring node for monitoring these controllers through a communication circuit. The another history recording method includes: an operating mode reporting step wherein, at a download start time for a file from an engineering tool that is connected through a communication circuit, an operating status reporting portion of the controller reports to the device monitoring node that a specific operating mode has been started, and, when downloading of the file has been terminated, reports to the device monitoring node that the specific operating mode has been terminated; a device monitoring step wherein a device monitoring portion of the device monitoring node monitors each controller intermittently, through the communication line, records, to a history recording portion, an operating status that is obtained for each aforementioned controller; and a monitoring controlling step wherein a monitoring controlling portion of the device monitoring node pauses, in the device monitoring portion, recording of the operating status of the applicable controller into the history recording portion in response to a report from the controller that a specific operating mode has been started, and restarts, in the device monitoring portion, recording of the operating status of the applicable controller into the history recording portion in response to a report from the controller that the specific operating mode has been terminated.

In the present invention, during an interval wherein a controller is in a specific operating mode, the monitoring operation relative to that controller, or the operation for recording, into the history recording portion, the operating status acquired from that controller, by the device monitoring portion is stopped based on specific operating mode started/stopped reports from the controller. This makes it possible to avoid needless recording, in the history recording portion, of operating statuses, such as the operating history or warning history, relating to the downloading operations wherein controllers download files from the engineering tools.

### BRIEF DESCRIPTIONS OF THE DRAWINGS

FIG. 1 is a block diagram illustrating an example configuration of a facility controlling system according to Example.

FIG. 2 is a sequence diagram illustrating the device monitoring operation of a device monitoring node.

FIG. 3 is a flowchart illustrating a monitoring controlling operation of a device monitoring node according to the Example.

FIG. 4 is a sequence diagram illustrating an example of operation of the device monitoring operation according to the Example (when operating properly).

FIG. 5 is a sequence diagram illustrating an example of operation of the device monitoring operation according to the Example (when there is a fault).

FIG. 6 is a flowchart illustrating a monitoring controlling operation of a device monitoring node according to Another Example.

FIG. 7 is a sequence diagram illustrating an example of operation of the device monitoring operation according to the Another Example (when operating properly).

FIG. 8 is a sequence diagram illustrating an example of operation of the device monitoring operation according to the Another Example (when there is a fault).

### DETAILED DESCRIPTION

Forms for carrying out the present invention will be explained next in reference to the figures.

### EXAMPLE

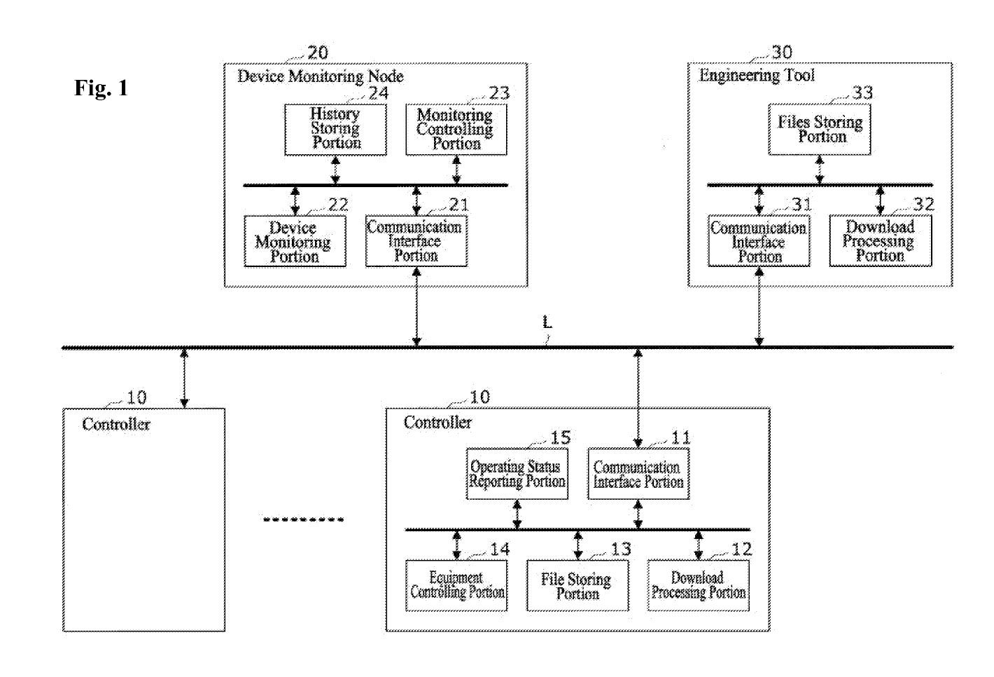

First of all, a facility controlling system 1 according to Example according to the present disclosure will be explained in reference to FIG. 1. FIG. 1 is a block diagram illustrating an example of a structure of a facility controlling system according to the Example. This facility controlling system 1 is a facility controlling system for monitoring/controlling building facility, such as in a building or an industrial plant, and is provided with a plurality of controllers 10, a device monitoring node 20, and an engineering tool 30 as the primary structures therein.

The controller 10, as a whole, is made from a controlling device that has a CPU, and has a function for downloading files for, for example, programs and settings data, from an engineering tool 30, and a function for controlling remotely, based on these programs and settings data, various types of equipment instruments that are installed within the building facility. Along with application programs for controlling the various types of equipment instruments remotely, the programs that are downloaded from the engineering tool 30 include firmware for controlling the operation of the controller 10. Moreover, for the settings data as well, there are settings data used by the firmware, along with the settings data used by the application programs.

As a whole, the device monitoring node 20 is made from an information processing device such as a server device, which has a function of monitoring the operating statuses of various controllers 10 through exchanging messages with the various controllers 10 through communication circuits L, and for recording as history the transitions in operating statuses of each of the controllers 10.

As a whole, the engineering tool 30 is made from an information processing device such as a personal computer, and has functions for distributing to each of the controllers 10, through communication circuits L, the programs and settings data used by the individual controllers 10.

In the present invention, the controller 10 reports, to the device monitoring node, starting/ending of a specific operating mode when downloading a file from the engineering tool 30, and the device monitoring node 20, in response to these reports, pauses monitoring of the controller 10, and recording of the operating status thereof, during the specific operating mode.

### Controller

The details of a structure of a controller 10 according to the present example will be explained next in reference to FIG. 1. The controller 10 is provided with a communication interface portion 11, a download processing portion 12, a file storing portion 13, an instrument controlling portion 14, and an operating status reporting portion 15, as the primary functional portions thereof. Of these functional portions, the instrument controlling portion 14 is achieved through the CPU of the controller 10 executing an application program in the file storing portion 13. Moreover, the download processing portion 12 and the operating status reporting portion 15 are achieved through the CPU of the controller 10 executing firmware within the file storing portion 13.

The communication interface portion 11 has a communication circuit for carrying out data communication through a communication circuit L such as a LAN, or the like, and has a function for exchanging various types of messages and files between the device monitoring node 20 and the engineering tool 30. The download processing portion 12 has a function for downloading files, such as programs and settings data, from the engineering tool 30 through the communication interface portion 11, and for saving them to a file storing portion 13 made from a semiconductor memory or a hard disk. The instrument controlling portion 14 has a function for controlling remotely various types of equipment instruments that are installed in the building facility, based on programs and settings data that are stored in the file storing portion 13.

The operating status reporting portion 15 has a function for sending back its own operating status in response to an operating status query from the device monitoring node 20, a function for reporting, to the device monitoring node 20, the start of a specific operating mode through the communication interface portion 11 at the time of the start of a download when the download processing portion 12 begins downloading a file from the engineering tool 30, and a function for reporting the end of the specific operating mode to the device monitoring node 20 through the communication interface portion 11 at the time of the end of a download when the downloading of the file has ended.

### Device Monitoring Node

A structure for a device monitoring node 20 according to the present example will be explained next in reference to FIG. 1. The device monitoring node 20 is provided with a communication interface portion 21, a device monitoring portion 22, a monitoring controlling portion 23, and a history recording portion 24, as the primary functional portions thereof. Of these functional portions, the device monitoring portion 22 and the monitoring controlling portion 23 are achieved through the CPU of the device monitoring node 20 executing a program within a storing portion (not shown).

The communication interface portion 21 has a communication circuit for performing data communication through the communication circuit L, and has a function for exchanging various types of messages with the controllers 10. The device monitoring portion 22 has a function for intermittently monitoring the operating statuses of the controllers 10, through exchanging various types of messages with the controllers 10 through the communication interface portion 21, and a function for recording the operating status is obtained for each of the controllers 10 into a history recording portion 24 that is made from a hard disk or from semiconductor memory.

The monitoring controlling portion 23 has a function for pausing monitoring of a controller 10, in the device monitoring portion 22, in response to a report from that controller 10, through the communication interface portion 21, that a specific operating mode has been started, and a function for restarting monitoring of the controller 10, in the device monitoring portion 22, in response to a report from that controller 10, through the communication interface portion 21, that the specific operating mode has been terminated.

### Engineering Tool

FIG. 1 will be referenced next in explaining in detail a structure for an engineering tool 30 relating to the present example. The engineering tool 30 is provided with a communication interface portion 31, a download processing portion 32, and a file storing portion 33, as the primary functional portions thereof. Of these functional portions, the download processing portion 32 is achieved through a CPU of the engineering tool 30 executing a program from in a storing portion (not shown).

The communication interface portion 31 has a communication circuit for carrying out data communication through the communication circuit L, and has a function for exchanging various types of messages and files with the controllers 10. The download processing portion 32 has a function for distributing, through the communication interface portion 31, files such as programs, settings data, and the like, from within a file storing portion 33, made from a hard disk or semiconductor memory, to the controllers 10.

### Operations in the Example

The operations of the facility controlling system 1 according to the present example will be explained next in reference to the drawings.

### Device Monitoring Operations

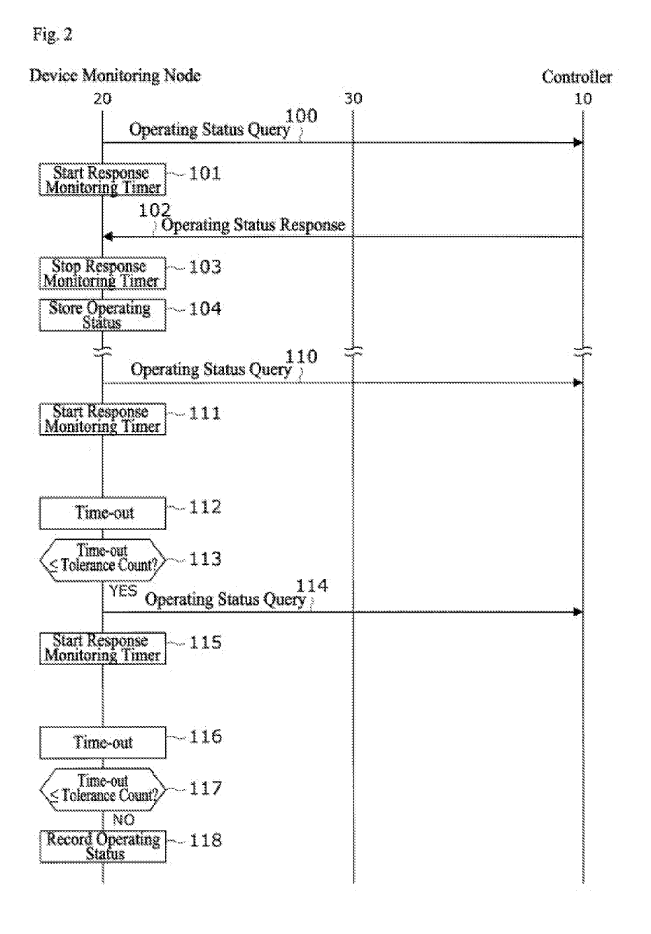

The device monitoring operations of the device monitoring node 20 will be explained first in reference to FIG. 2. FIG. 2 is a sequence diagram illustrating the device monitoring operations of the device monitoring node. The device monitoring node 20 executes the device monitoring operations in FIG. 2 at prescribed intervals through the device monitoring portion 22.

First, in response to the arrival at the monitoring time, at the prescribed interval, the device monitoring portion 22 sends an operating status query message, for performing a query regarding the operating status of a controller 10, to the applicable controller 10 from the communication interface portion 21 through the communication circuit L (Step 100), and activates a response monitoring timer (Step 101). This response monitoring timer is a timer for measuring the monitoring interval for monitoring for an operating status response from the controller 10 in response to the operating status query message.

Upon receipt of the operating status query message from the device monitoring node 20 through the communication interface portion 11, the controller 10 returns an operating status reporting message, which includes the operating status thereof, to the device monitoring node 20 from the communication interface portion 11 through the communication circuit L (Step 102).

Upon receipt of the operating status reporting message from the controller 10 by the communication interface portion 21, the device monitoring portion 22 stops the response monitoring timing (Step 103), and obtains, and records in the history recording portion 24, the operating status of the applicable controller 10 that is included in the operating status reporting message (Step 104). Thereafter, the device monitoring portion 22 stands by until the arrival at the monitoring time, formed by the prescribed interval, and then, in response to the arrival at the monitoring time, repeats the device monitoring operation starting with Step 100.

While the explanation set forth above is an explanation for a case wherein the controller 10 is undergoing normal operations, if a problem were to occur in the controller 10, the operations would be as follows. First, in response to the arrival at the monitoring time, at the prescribed interval, the device monitoring portion 22 sends an operating status query message to the applicable controller 10 from the communication interface portion 21 through the communication circuit L (Step 110), and activates a response monitoring timer (Step 111).

Here a problem has occurred in the controller 10, so it may not be possible to send back an operating status reporting message in response to the operating status query message from the device monitoring node 20, in which case the response monitoring timer will time-out (Step 112). In response to the response monitoring timer timing-out, the device monitoring portion 22 checks the number of times in a row that the response monitoring timer has timed out (termed the “continuous timeout count”), and if the continuous timeout count is equal to or less than a tolerance count (Step 113: YES), then the operating status query message is sent again to the controller 10 from the communication interface portion 21 through the communication circuit L (Step 114), and the response monitoring timer is activated (Step 115).

If, after doing this, the operating status reporting message is not returned from the controller 10, then the device monitoring portion 22 repeatedly sends the operating status query message with each monitoring interval that is timed by the response monitoring timer until the continuous timeout count of the response monitoring timer has arrived at the tolerance count. On the other hand, if, when the continuous timeout count of the response monitoring timer is checked in response to the response monitor timer timing-out (Step 116), the continuous timeout count is greater than the tolerance count (Step 117: NO), then the device monitoring portion 22 evaluates that a problem fault has occurred in the controller 10, and records, in the history recording portion 24, an operating status to that effect (Step 118).

Through this, a fault in the controller 10 is identified through a time-limiting control operation by the device monitoring portion 22 when, despite the operating status query message being sent a number of times that is equal to the tolerance count, no operating status reporting message is returned from the controller 10.

### Monitoring Controlling Operations

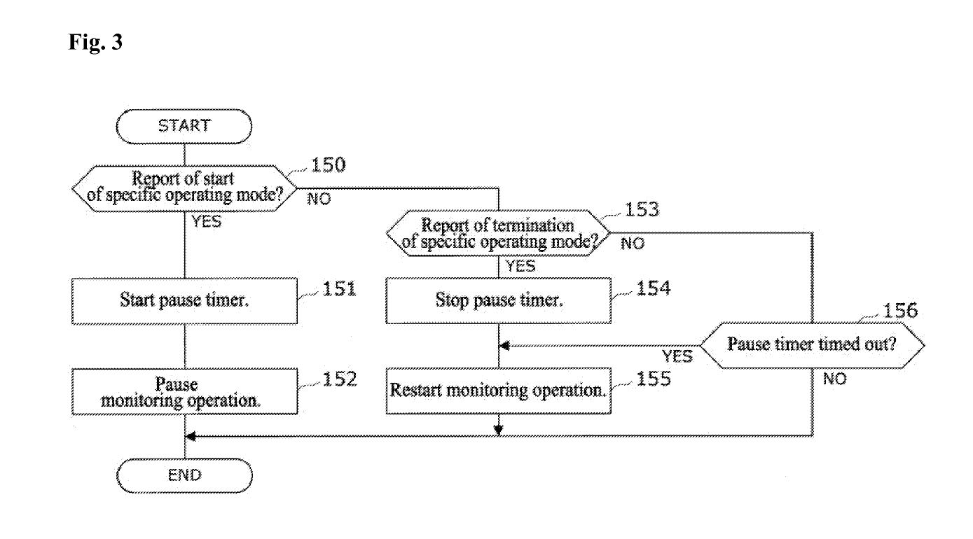

The monitoring controlling operations in the device monitoring node 20 will be explained next in reference to FIG. 3. FIG. 3 is a flowchart illustrating a monitoring controlling operation of a device monitoring node according to the Example. The device monitoring node 20 carries out the monitoring controlling operations of FIG. 3 in response to a report from a controller 10, through the monitoring controlling portion 23, that a specific operating mode has been started or terminated.

First, upon receipt of a Specific Operating Mode Started message, from the communication interface portion 21, reporting from the controller 10 that a specific operating mode has been started (Step 150: YES), the monitoring controlling portion 23 activates a pause timer (Step 151) and pauses the monitoring operation by the device monitoring portion 22 in relation to the applicable controller 10 (Step 152). This pause timer is a timer for measuring a pause interval over which the monitoring operation in the device monitoring portion 22 is to be paused.

Moreover, in response to receipt, through the communication interface portion 21, of a Specific Operating Mode Terminated message, for reporting from the controller 10 that a specific operating mode has been terminated (Step 153: YES), rather than the Specific Operating Mode Started message (Step 150: NO), the monitoring controlling portion 23 stops the pause timer (Step 154), and restarts the monitoring operation in relation to the controller 10 in the device monitoring portion 22 (Step 155).

Moreover, if the pause timer times-out (Step 156: YES) prior transmission of the Specific Operating Mode Terminated message (Step 153: NO), then the monitoring controlling portion 23 jumps to Step 155, and restarts the monitoring operation in the device monitoring portion 22 in relation to the applicable controller 10.

In this way, during the time over which the controller 10 is in the specific operating mode, monitoring of the applicable controller 10 by the device monitoring portion 22 is paused is based on reports from the controller 10 that the specific operating mode has been started or terminated. As a result, the operating status of the controller 10 is not acquired by the device monitoring node 20 while the specific operating mode is in effect. This makes it possible to avoid needlessly recording, to the history recording portion 24, operating statuses for the operating history, warning history, and the like in relation to a download operation wherein the controller 10 is downloading a file from the engineering tool 30.

### Example of Operation

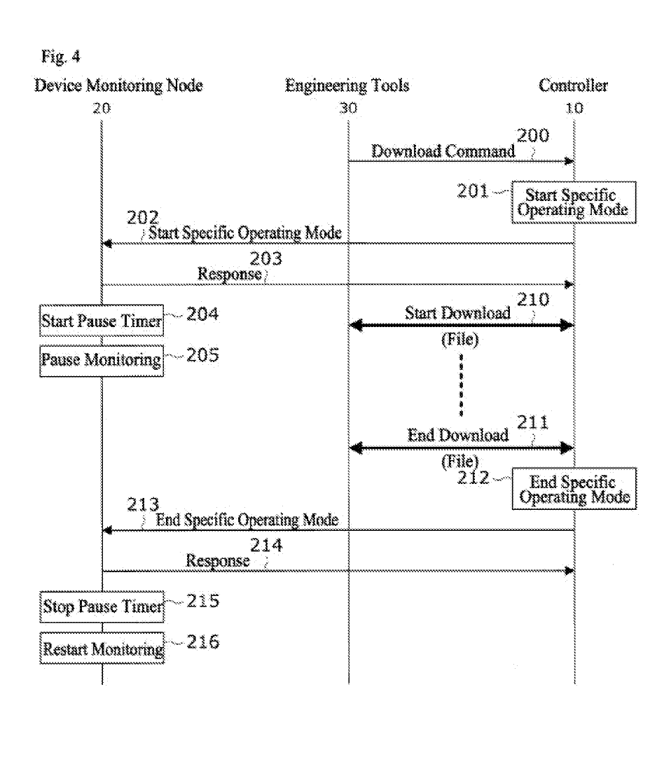

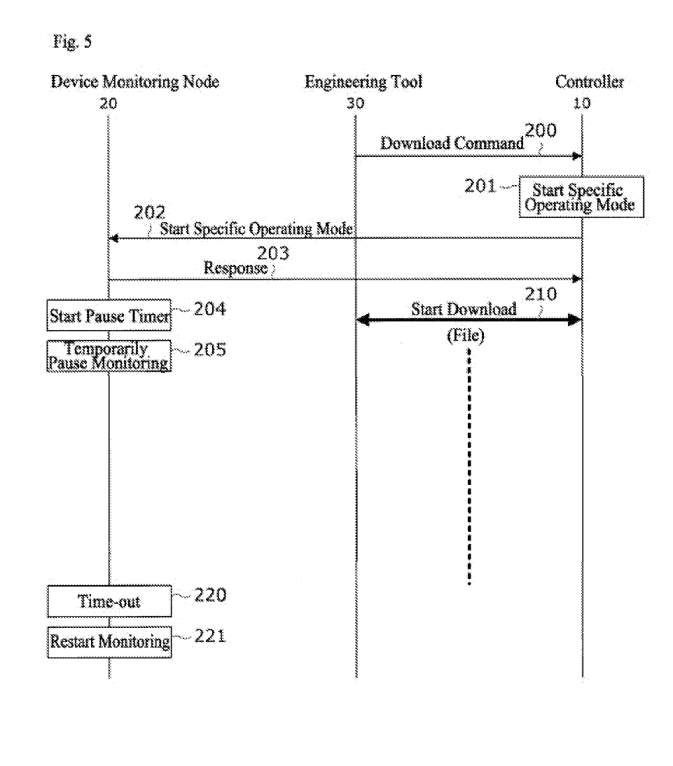

An example of operation of a device monitoring operation in a facility controlling system 1 according to the present example will be explained next in reference to FIG. 4 and FIG. 5. FIG. 4 is a sequence diagram illustrating an example of operation of the device monitoring operation according to the Example (when operating properly). FIG. 5 is a sequence diagram illustrating an example of operation of the device monitoring operation according to the Example (when there is a fault).

The example operation for the device monitoring operation (during normal operation) will be explained first in reference to FIG. 4. When downloading a file from the engineering tool 30 to the controller 10, a download command message is sent from the engineering tool 30 to the controller 10 (Step 200).

In response to the download command from the engineering tool 30, received by the communication interface portion 11, the download processing portion 12 of the controller 10 starts a specific operating mode as the operating mode thereof (Step 201). In response to the starting of this specific operating mode, the operating status reporting portion 15 sends a Specific Operating Mode Started message from the communication interface portion 11 through the communication circuit L to the device monitoring node 20 (Step 202).

In response to the Specific Operating Mode Started message from the controller 10, received by the communication interface portion 21, the monitoring controlling portion 23 of the device monitoring node 20 returns an acknowledgment for the Specific Operating Mode Started message (Step 203). Furthermore, the monitoring controlling portion 23 activates the pause timer (Step 204), and pauses the monitoring operation for the applicable controller 10 by the device monitoring portion 22 (Step 205).

The download processing portion 12 of the controller 10, after starting the specific operating mode, exchanges messages with the engineering tool 30 to start downloading a file (Step 210). The download processing portion 12 thereby saves the file data, received from the engineering tool 30, sequentially as a file in the file storing portion 13.

Thereafter, in response to the end of downloading of the file (Step 211), the download processing portion 12 terminates the specific operating mode as the operating mode thereof (Step 212). In response to the termination of the specific operating mode, the operating status reporting portion 15 sends a Specific Operating Mode Terminated message to the device monitoring node 20 through the communication circuit L from the communication interface portion 11 (Step 213).

In response to the Specific Operating Mode Terminated message from the controller 10, received by the communication interface portion 21, the monitoring controlling portion 23 of the device monitoring node 20 returns an acknowledgment for the Specific Operating Mode Terminated message (Step 214). Furthermore, the monitoring controlling portion 23 stops the pause timer (Step 215), and restarts the monitoring operation for the applicable controller 10 by the device monitoring portion 22 (Step 216).

An example of the device monitoring operation (when there is a problem) will be explained next in reference to FIG. 5. In FIG. 5, those steps that are identical or equivalent to those in FIG. 4 are assigned identical codes. When downloading a file from the engineering tool 30 to the controller 10, a download command message is sent from the engineering tool 30 to the controller 10 (Step 200).

In response to the download command from the engineering tool 30, received by the communication interface portion 11, the download processing portion 12 of the controller 10 starts a specific operating mode as the operating mode thereof (Step 201). In response to the starting of this specific operating mode, the operating status reporting portion 15 sends a Specific Operating Mode Started message from the communication interface portion 11 through the communication circuit L to the device monitoring node 20 (Step 202).

In response to the Specific Operating Mode Started message from the controller 10, received by the communication interface portion 21, the monitoring controlling portion 23 of the device monitoring node 20 returns an acknowledgment for the Specific Operating Mode Started message (Step 203). Furthermore, the monitoring controlling portion 23 activates the pause timer (Step 204), and pauses the monitoring operation for the applicable controller 10 by the device monitoring portion 22 (Step 205).

The download processing portion 12 of the controller 10, after starting the specific operating mode, exchanges messages with the engineering tool 30 to start downloading a file (Step 210). The download processing portion 12 thereby saves the file data, received from the engineering tool 30, sequentially as a file in the file storing portion 13.

Thereafter, if the pause timer times-out prior to sending of the Specific Operating Mode Terminated message from the controller 10 (Step 220), then the monitoring controlling portion 23 of the device monitoring node 20 restarts the monitoring operation for the applicable controller 10 within the device monitoring portion 22 (Step 221).

This makes it possible to avoid needlessly recording, to the history recording portion 24, operating statuses for the operating history, warning history, and the like in relation to an operation wherein a file is downloaded to the controller 10 from the engineering tool 30. Additionally, if the download operation is not completed properly during the pause interval, the monitoring operation is restarted by the device monitoring node 20, so the operating status of the controller 10 is acquired by the device monitoring node 20 and recorded in the history recording portion 24. The occurrence of a fault in the controller 10 is recorded in the history thereby, enabling handling of the fault and analysis of the fault to be carried out properly.

In this way, in the present example the monitoring controlling portion 23 of the device monitoring node 20, in response to a report from the controller 10 that the specific operating mode has been started, pauses monitoring for that particular controller 10 in the device monitoring portion 22, and, in response to a report from the controller 10 that the specific operating mode has been terminated, restarts monitoring for the applicable controller 10 in the device monitoring portion 22.

As a result, during the time over which the controller 10 is in the specific operating mode, monitoring of the applicable controller 10 by the device monitoring portion 22 is paused is based on reports from the controller 10 that the specific operating mode has been started or terminated. As a result, the operating status of the controller 10 is not acquired by the device monitoring node 20 while the specific operating mode is in effect. This makes it possible to avoid needlessly recording, to the history recording portion 24, operating statuses for the operating history, warning history, and the like in relation to an operation wherein a file is downloaded to the controller 10 from the engineering tool 30.

Moreover, in the present example, the monitoring operation may be restarted if the pause in the monitoring operation in the device monitoring portion 22 reaches a pause interval. As a result, if the download operation in the controller 10 does not terminate properly within the pause interval, then the monitoring operation is restarted by the device monitoring node 20, so the operating status of the controller 10 is acquired by the device monitoring node 20 and recorded in the history recording portion 24. The occurrence of a fault in the controller 10 is recorded in the history thereby, enabling handling of the fault and analysis of the fault to be carried out properly.

### Another Example

A facility controlling system 1 according to Another Example according to the present disclosure will be explained next. In the Example, a case was explained wherein the monitoring controlling portion 23 of the device monitoring node 20, in response to a report from a controller 10 that a specific operating mode has been started, paused monitoring operations for the applicable controller 10 in the device monitoring portion 22, thereby positing the recording of the operating status of the controller 10 during a download operation. In the present example, the explanation will be for a case of pausing the recording operation for the operating status into the history recording portion 24, rather than pausing the monitoring operation.

In the present example the monitoring controlling portion 23 of the device monitoring node 20, has a function for pausing recording of the operating status of the applicable controller 10 into a history recording portion 24 in the device monitoring portion 22 in response to a report from the controller 10, received through the communication interface portion 21, that the specific operating mode has been started, and a function for restarting recording of the operating status of the applicable controller 10 into a history recording portion 24 in the device monitoring portion 22 in response to a report from the controller 10 that the specific operating mode has been terminated. The other structures in the present example are identical to those of the Example, so detailed explanations thereof are omitted here.

### Operation of the Another Example

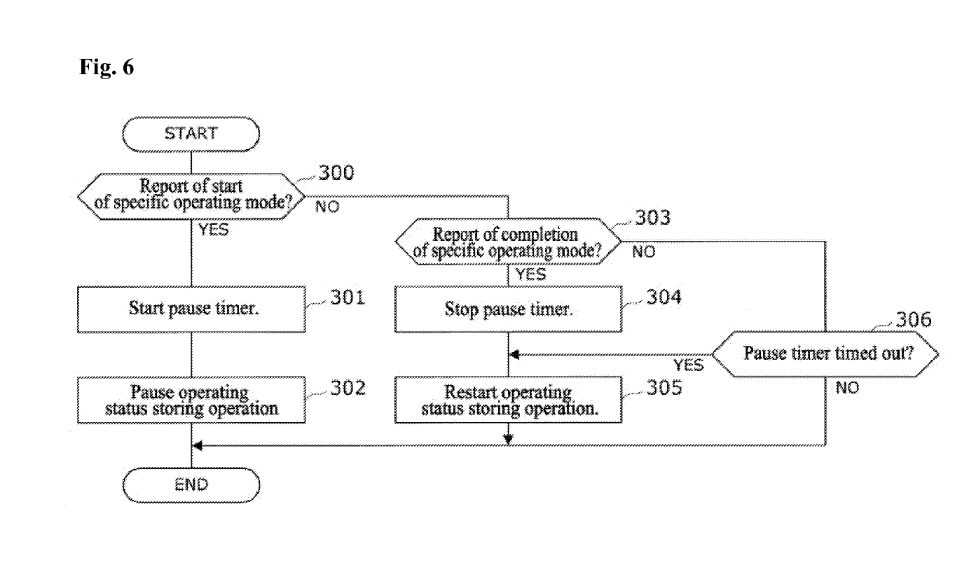

Monitoring controlling operations in device monitoring node 20 according to the present example will be explained next in reference to FIG. 6. FIG. 6 is a flowchart illustrating a monitoring controlling operation of a device monitoring node according to the Another Example. The device monitoring node 20 carries out the monitoring controlling operations of FIG. 6 in response to a report from a controller 10, through the monitoring controlling portion 23, that a specific operating mode has been started or terminated.

First, upon receipt of a Specific Operating Mode Started message, from the communication interface portion 21, reporting from the controller 10 that a specific operating mode has been started (Step 300: YES), the monitoring controlling portion 23 activates a pause timer (Step 301) and pauses the operation for recording the operating status of the applicable controller 10 into the history recording portion 24 by the device monitoring portion 22 (Step 302).

Moreover, in response to receipt, through the communication interface portion 21, of a Specific Operating Mode Terminated message, for reporting from the controller 10 that a specific operating mode has been terminated (Step 303: YES), rather than the Specific Operating Mode Started message (Step 300: NO), the monitoring controlling portion 23 stops the pause timer (Step 304), and restarts the operation for recording the operating status of the applicable controller 10 into the history recording portion 24 by the device monitoring portion 22 (Step 305).

Moreover, if the pause timer times-out (Step 306: YES) prior transmission of the Specific Operating Mode Terminated message (Step 303: NO), then the monitoring controlling portion 23 jumps to Step 305, and restarts the operation for recording the operating status of the applicable controller 10 into the history recording portion 24 by the device monitoring portion 22.

In this way, during the time over which the controller 10 is in the specific operating mode, the operation for recording the operating status of the applicable controller 10 into the history recording portion 24 by the device monitoring portion 22 is paused based on reports from the controller 10 that the specific operating mode has been started or terminated. This makes it possible to avoid needlessly recording, to the history recording portion 24, operating statuses for the operating history, warning history, and the like in relation to an operation wherein a file is downloaded to the controller 10 from the engineering tool 30.

### Example of Operation

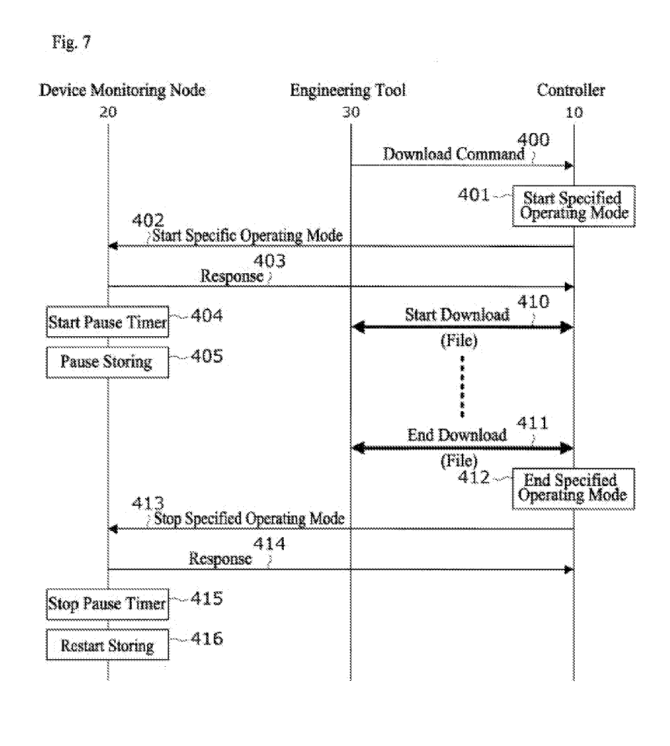

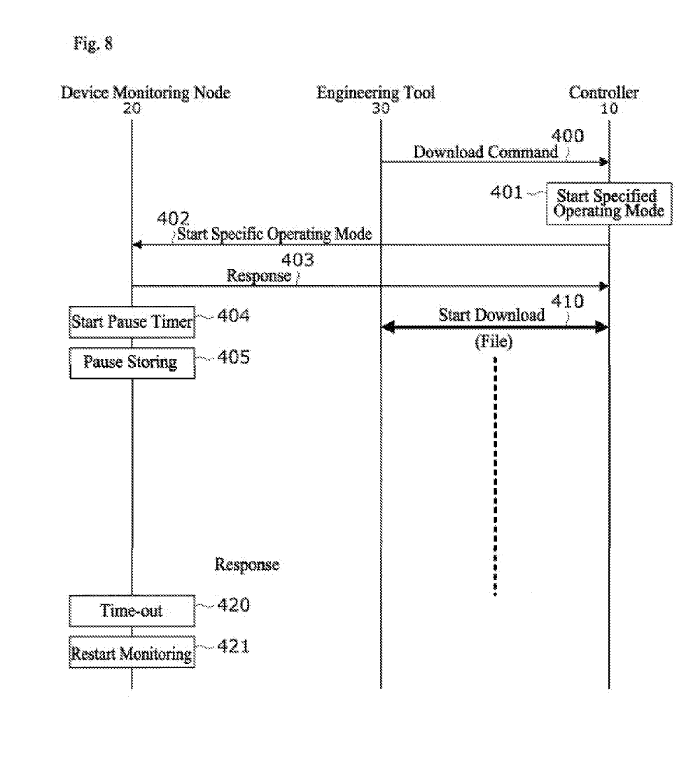

An example of operation of a device monitoring operation in a facility controlling system 1 according to the present example will be explained next in reference to FIG. 7 and FIG. 8. FIG. 7 is a sequence diagram illustrating an example of operation of the device monitoring operation according to the Another Example (when operating properly). FIG. 8 is a sequence diagram illustrating an example of operation of the device monitoring operation according to the Another Example (when there is a fault).

The example operation for the device monitoring operation (during normal operation) will be explained first in reference to FIG. 7. When downloading a file from the engineering tool 30 to the controller 10, a download command message is sent from the engineering tool 30 to the controller 10 (Step 400).

In response to the download command from the engineering tool 30, received by the communication interface portion 11, the download processing portion 12 of the controller 10 starts a specific operating mode as the operating mode thereof (Step 401). In response to the starting of this specific operating mode, the operating status reporting portion 15 sends a Specific Operating Mode Started message from the communication interface portion 11 through the communication circuit L to the device monitoring node 20 (Step 402).

In response to the Specific Operating Mode Started message from the controller 10, received by the communication interface portion 21, the monitoring controlling portion 23 of the device monitoring node 20 returns an acknowledgment for the Specific Operating Mode Started message (Step 403). Furthermore, the monitoring controlling portion 23 activates the pause timer (Step 404), and pauses the operation for recording the operating status of the applicable controller 10 into the history recording portion 24 by the device monitoring portion 22 (Step 405). This pause timer is a timer for measuring a pause interval over which the recording operation in the device monitoring portion 22 is to be paused.

The download processing portion 12 of the controller 10, after starting the specific operating mode, exchanges messages with the engineering tool 30 to start downloading a file (Step 410). The download processing portion 12 thereby saves the file data, received from the engineering tool 30, sequentially as a file in the file storing portion 13.

Thereafter, in response to the end of downloading of the file (Step 411), the download processing portion 12 terminates the specific operating mode as the operating mode thereof (Step 412). In response to the termination of the specific operating mode, the operating status reporting portion 15 sends a Specific Operating Mode Terminated message to the device monitoring node 20 through the communication circuit L from the communication interface portion 11 (Step 413).

In response to the Specific Operating Mode Terminated message from the controller 10, received by the communication interface portion 21, the monitoring controlling portion 23 of the device monitoring node 20 returns an acknowledgment for the Specific Operating Mode Terminated message (Step 414). Furthermore, the monitoring controlling portion 23 stops the pause timer (Step 415), and restarts the operation for recording the operating status of the applicable controller 10 into the history recording portion 24 by the device monitoring portion 22 (Step 416).

An example of the device monitoring operation (when there is a problem) will be explained next in reference to FIG. 8. In FIG. 8, those steps that are identical or equivalent to those in FIG. 7 are assigned identical codes. When downloading a file from the engineering tool 30 to the controller 10, a download command message is sent from the engineering tool 30 to the controller 10 (Step 400).

In response to the download command from the engineering tool 30, received by the communication interface portion 11, the download processing portion 12 of the controller 10 starts a specific operating mode as the operating mode thereof (Step 401). In response to the starting of this specific operating mode, the operating status reporting portion 15 sends a Specific Operating Mode Started message from the communication interface portion 11 through the communication circuit L to the device monitoring node 20 (Step 402).

In response to the Specific Operating Mode Started message from the controller 10, received by the communication interface portion 21, the monitoring controlling portion 23 of the device monitoring node 20 returns an acknowledgment for the Specific Operating Mode Started message (Step 403). Furthermore, the monitoring controlling portion 23 activates the pause timer (Step 404), and pauses the operation for recording the operating status of the applicable controller 10 into the history recording portion 24 by the device monitoring portion 22 (Step 405).

The download processing portion 12 of the controller 10, after starting the specific operating mode, exchanges messages with the engineering tool 30 to start downloading a file (Step 410). The download processing portion 12 thereby saves the file data, received from the engineering tool 30, sequentially as a file in the file storing portion 13.

Thereafter, if the pause timer times-out prior to sending of the Specific Operating Mode Terminated message from the controller 10 (Step 420), then the monitoring controlling portion 23 of the device monitoring node 20 restarts the operation for recording the operating status of the applicable controller 10 into the history recording portion 24 by the device monitoring portion 22 (Step 421).

This makes it possible to avoid needlessly recording, to the history recording portion 24, operating statuses for the operating history, warning history, and the like in relation to an operation wherein a file is downloaded to the controller 10 from the engineering tool 30. Additionally, if the download operation is not completed properly during the pause interval, the recording operation is restarted by the device monitoring node 20, so the operating status of the controller 10 is acquired by the device monitoring node 20 and recorded in the history recording portion 24. The occurrence of a fault in the controller 10 is recorded in the history thereby, enabling handling of the fault and analysis of the fault to be carried out properly.

In this way, in the present example the monitoring controlling portion 23 of the device monitoring node 20, in response to a report from the controller 10 that the specific operating mode has been started, pauses the operation for recording the operating status of the applicable controller 10 into the history recording portion 24 by the device monitoring portion 22, and, in response to a report from the controller 10 that the specific operating mode has been terminated, restarts the operation for recording the operating status of the applicable controller 10 into the history recording portion 24 by the device monitoring portion 22.

As a result, during the time over which the controller 10 is in the specific operating mode, the recording operation for the applicable controller 10 by the device monitoring portion 22 is paused is based on reports from the controller 10 that the specific operating mode has been started or terminated. This makes it possible to avoid needlessly recording, to the history recording portion 24, operating statuses for the operating history, warning history, and the like in relation to an operation wherein a file is downloaded to the controller 10 from the engineering tool 30.

Moreover, in the present example, the monitoring operation may be restarted if the pause in the monitoring operation in the device monitoring portion 22 reaches a pause interval. As a result, if the download operation in the controller 10 does not terminate properly within the pause interval, then the recording operation is restarted by the device monitoring node 20, so the operating status of the controller 10 is acquired by the device monitoring node 20 and recorded in the history recording portion 24. The occurrence of a fault in the controller 10 is recorded in the history thereby, enabling handling of the fault and analysis of the fault to be carried out properly.

### Extended Examples

While the present disclosure was explained above in reference to the examples, the present disclosure is not limited by the examples set forth above. The structures and details of the present disclosure may be modified in a variety of ways, as can be understood by those skilled in the art, within the scope of the present disclosure. Moreover, the present disclosure may be embodied through combining the various examples, insofar as there are no contradictions.

In the respective examples set forth above, as illustrated in FIG. 4, cases were explained for examples wherein the controller 10 reported, to the device monitoring node 20, starting of the specified operation in response to a download command from the engineering tool 30; however there is no limitation thereto. For example, if the engineering tool 30 stores the system configuration, such as the address of the device monitoring node 20, as a system tool, then the report, to the device monitoring node 20, of the start of the specified operation may be from the engineering tool 30. Moreover, if the engineering tool 30 does not store the system structure, such as a field instrument, then the report, to the device monitoring node 20 from the engineering tool 30, for the start of the specified operation may be performed by querying the controller 10 for the address of the device monitoring node 20, and then reporting based on the address that is acquired.

Moreover, in the respective examples set forth above the cases were explained for examples wherein, in the device monitoring operation of the device monitoring node 20, illustrated in FIG. 2, an operating status query message was sent from the device monitoring node 20 to the controller 10 in response to the arrival at the monitoring time, and the operating status of the controller 10 was acquired through the operating status reporting message from the controller 10 in reply thereto; however there is no limit thereto.

For example, in the operating status reporting portion 15 of the controller 10, an operating status reporting message that includes the operating status may be sent autonomously to the device monitoring node 20 from the communication interface portion 11 through the communication circuit L in response to the arrival at the monitoring time that consists of the prescribed interval. Doing so enables a reduction in the process overhead in the device monitoring node 20 because of the ability to eliminate the operation for sending the operation status query messages to the individual controllers 10 in the device monitoring portion 22 of the device monitoring node 20.

Note that because, in this case, the operating status reporting message is reported by the controller 10 at the prescribed intervals, the activation of the response monitoring timer in the device monitoring operation in FIG. 2 may be, for example, immediately after the response monitoring timer is stopped.

Moreover, in each of the examples set forth above, when the operating status reporting portion 15 of the controller 10 sends, to the Specific Operating Mode Started message to the device monitoring node 20, it may report the length of time of the specific operating mode required for the operation for downloading in the applicable controller 10, and the device monitoring portion 22 of the device monitoring node 20 may use the pause timer to measure that length of time for the specific operating mode, reported in the Specific Operating Mode Started message, as the pause interval. This enables more accurate monitoring of the occurrence of faults in the controller 10 in the download operation, through the ability to use the optimal pause interval for the specific controller 10 or for the specific file size that is to be downloaded.

Furthermore, a function for reporting a switch in the operating mode to the device monitoring node 20 when the controller 10 executes a download operation may be applied by the facility controlling system 1. For example, in BACnet there is a function for reporting the removal/installation of a controller. Consequently, it is possible to avoid recording the history regarding the switching of the operating mode through changing the settings so as to apply such a function in each example.

1. A facility controlling system comprising:
a plurality of controllers that controls remotely various types of equipment instruments that are installed in building facility, and
a device monitoring node that monitors these controllers through a communication circuit, wherein
the controller comprises
an operating status reporting portion that reports to the device monitoring node, at a download start time for starting downloading of a file from an engineering tool that is connected through a communication circuit, that a specific operating mode has been started, and reports to the device monitoring node, at a download termination time when downloading of the file has been terminated, that the specific operating mode has been terminated, and
the device monitoring node comprises
a device monitoring portion that intermittently monitors the individual controllers through the communication circuit and records the operating statuses obtained into a history recording portion for each individual controller, and
a monitoring controlling portion that pauses monitoring in the device monitoring portion, for the applicable controller, in response to a report from the controller that a specific operating mode has been started, and restarts monitoring in the device monitoring portion, for the applicable controller, in response to a report from the controller that the specific operating mode has been terminated.

2. A facility controlling system comprising:
a plurality of controllers that controls remotely various types of equipment instruments that are installed in building facility, and
a device monitoring node that monitors these controllers through a communication circuit, wherein
the controller comprises
an operating status reporting portion that reports, to the device monitoring node, at a download start time for a file from an engineering tool that is connected through a communication circuit, that a specific operating mode has been started, and reports, to the device monitoring node, when downloading of the file has been terminated, that the specific operating mode has been terminated, and
the device monitoring node comprises
a device monitoring portion that intermittently monitors the individual controllers through the communication circuit and recording the operating statuses obtained into a history recording portion for each individual controller, and
a monitoring controlling portion that pauses recording, into the recording history portion in the device monitoring portion, of the operating status of the applicable controller, in response to a report from the controller that a specific operating mode has been started, and restarts recording, into the recording history portion in the device monitoring portion, of the operating status of the applicable controller, in response to a report from the controller that the specific operating mode has been terminated.

3. A history recording method used in a facility controlling system that includes a plurality of controllers for controlling remotely various types of equipment instruments that are installed in building facility, and a device monitoring node for monitoring these controllers through a communication circuit, the history recording method comprising:
an operating mode reporting step wherein, at a download start time for a file from an engineering tool that is connected through a communication circuit, an operating status reporting portion of the controller reports to the device monitoring node that a specific operating mode has been started, and, when downloading of the file has been terminated, reports to the device monitoring node that the specific operating mode has been terminated;
a device monitoring step wherein a device monitoring portion of the device monitoring node monitors each controller intermittently, through the communication line, records, to a history recording portion, an operating status that is obtained for each aforementioned controller; and
a monitoring controlling step wherein a monitoring controlling portion of the device monitoring node pauses, in the device monitoring portion, monitoring of the applicable controller in response to a report from the controller that a specific operating mode has been started, and restarts, in the device monitoring portion, monitoring of the applicable controller in response to a report from the controller that the specific operating mode has been terminated.

4. A history recording method used in a facility controlling system that includes a plurality of controllers for controlling remotely various types of equipment instruments that are installed in building facility, and a device monitoring node for monitoring these controllers through a communication circuit, the history recording method including:
an operating mode reporting step wherein, at a download start time for a file from an engineering tool that is connected through a communication circuit, an operating status reporting portion of the controller reports to the device monitoring node that a specific operating mode has been started, and, when downloading of the file has been terminated, reports to the device monitoring node that the specific operating mode has been terminated;
a device monitoring step wherein a device monitoring portion of the device monitoring node monitors each controller intermittently, through the communication line, records, to a history recording portion, an operating status that is obtained for each aforementioned controller; and
a monitoring controlling step wherein a monitoring controlling portion of the device monitoring node pauses, in the device monitoring portion, recording of the operating status of the applicable controller into the history recording portion in response to a report from the controller that a specific operating mode has been started, and restarts, in the device monitoring portion, recording of the operating status of the applicable controller into the history recording portion in response to a report from the controller that the specific operating mode has been terminated.
